(19) United States
(12) Patent Application Publication
(10) Pub. No.: US 2007/0022231 A1
(43) Pub. Date: Jan. 25, 2007

(54) Method and System for Transferring a Stream of Data

(76) Inventors: Rolf Fritz, Waldenbuch (DE); Andreas Koenig, Leonberg (DE); Susan Marie Rubow, Hyde Park, NY (US); Christopher Smith, Tamm (DE); Gerhard Zilles, Jettingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/458,504

(22) Filed: Jul. 19, 2006

(30) Foreign Application Priority Data
Jul. 25, 2005 (EP) 05106813.8

(51) Int. Cl. G06F 5/00

(52) U.S. Cl. 710/52

(57) ABSTRACT

The present invention relates to a method and system for transferring a stream of data from a first higher-speed subsystem of a computer to a plurality of lower speed subsystems, wherein the stream is structured in a sequence of blocks of different bit length, and a block is to be transferred to a specific one of said lower-speed subsystems. A corresponding method uses a queue for buffering the data, which includes control bits [c], [u], [k] to encode the further processing relevant for the association of the data block with a specific one of said lower-speed subsystems, when the queue entry is decoded at the output register of the queue.

### BACKGROUND OF THE INVENTION

1. Field of the Invention

The present invention relates to data transfer between different subsystems of a computer, and in particular, to a method and respective system for transferring a stream of data from a first higher-speed subsystem of a computer to a plurality of lower speed subsystems, wherein the stream is structured in a sequence of blocks of different bit length, and a block is to be transferred to a specific one of said lower-speed subsystems.

2. Description and Disadvantages of Prior Art

Between single subsystems of a computer data and commands are transported via multiple bus systems in blocks of different bit length. Thereby, the term “block” is understood to represent generally a piece of information, i.e., an information packet, such as above commands including or excluding respective data, wherein a block makes sense to be processed consistently with a single semantic rule, as for example “decode command”, or “pass block to subsystem X”, etc. A general technical problem emerges, when a transport crosses subsystem borders and the data speed in the source subsystem is higher than the data speed in the target system such that data cannot be directly processed in a synchronous way as it emerges at the subsystem border.

A typical example is disclosed in IBM journal of research and development, volume 48 no. 4, May/July 2004, page 449 to 459 and in particular FIG. 2 and text in the right column of page 450. FIG. 1 of the present patent application is a simplified and more abstract representation of the above cited figure. In this prior art the fast subsystem is the processor 10 and the low speed subsystems are the different I/O subsystems 22. They are interconnected by a L2 Cache interface 20. A switch 12 is provided which connects the high speed input stream to a plurality of speed-matching buffers 11A and 11B abbreviated as SMB, wherein each of said SMBs consists of an 8-deep command (CMD) queue 13, 14, and data buffers for fetch data (FD) 15, 16 and for store data (SD) 17, 18. Those buffers 15, 16, 17, 18 temporarily store the incoming data until they are ready to be processed by one of the low speed subsystems connected to this interface. Concurrently, those buffers have an additional function to enable for an in-order processing of commands in this specific example, where commands form part of the input stream.

As a matter of fact the incoming input stream is very inhomogeneous in packet size, which results in a quite inefficient use of the buffers. Nevertheless, the buffer size must be designed quite large in order to cope with payload peaks.

A further disadvantage consists in the fact that two different sets of buffers are needed in order to implement the two different functions of speed matching and in-order alignment in case when program commands are transferred via the bus system.

### OBJECTIVES OF THE INVENTION

It is thus the objective of the present invention to provide a data management at the above-mentioned subsystem borders which takes a more efficient use of the storage resources.

### SUMMARY AND ADVANTAGES OF THE INVENTION

This objective of the invention is achieved by the features stated in enclosed independent claims. Further advantageous arrangements and embodiments of the invention are set forth in the dependent claims.

The basic idea of the present invention is to use a queue instead of the before-mentioned plurality of buffers and using this queue both, for speed matching and for alignment purposes, if the latter plays a major role. A write client logic is inserted at the upstream write end of the queue which inserts certain control bits into a queue entry at predetermined entry locations. Those control bits are evaluated by a read client logic reading those control bits from the output register of the queue, which evaluation yields to respective signalling of the queue control logic, thus implementing steps like stopping the queue read process, starting the queue read process with the last or the next entry again, etc.

Thus, according to this basic aspect of the present invention the payload of the input stream is cut at predefined locations which are appropriate for the respective prevailing payload data and is stored in respective queue entries together with additional control information which can immediately be evaluated at the output register of the queue. Thus, at the end of the queue the queue entries can be read out and a correct processing of the payload can be derived by evaluating the control bits also comprised of a respective queue entry. By that the advantage results that the queue output evaluation logic is not required to be programmed by semantics which result from the content of the payload.

This approach solves the difficulty to cope with the constraint in this architecture that at the output register of the queue only a predetermined number of blocks—here only one—can be processed at a time. The size of the queue entries is typically so large that a queue entry may be filled with a plurality of blocks, if the block length is short enough. An example for a short block is when the block contains a simple command without data or if it contains just a small set of data. On the other hand a block can also have a big length such that it spans over more than a single queue entry.

According to a preferred aspect of the present invention a specific control bit is provided, which is enabled when the respective queue entry which comprises it, shall be repeatedly displayed at the output register of the queue. This handles the problem of short blocks of which in a first read process the first block is processed and in a subsequent read the next block is processed.

A further control bit can be preferably provided which tells if or if not the respective queue entry must be repeatedly displayed at the output register of the queue after the queue read process was stopped.

This is needed to ensure that the queue read process can stop even if there is a part of a new block in a queue entry that contains data associated to the previous block. For example, a queue entry must be read before the read process stops, because there may be a last part of an already started block, or multiple blocks-starts are within one entry. However, the last block-start may not be allowed to be decoded yet, because there is the danger of an under run. In case of a slow writer; this is one reason why the queue read process must stop here. In such a case such an entry must be repeated when the queue read process starts again.

Further preferably, a countdown control information is implemented which indicates the number of queue entries still to follow upstream of a current queue entry, wherein the following queue entries comprise the continuation of the latest block in the current queue entry. In other words, a countdown indicator of the control bits indicates the number of required queue entries needed for finishing a current packet. If there is at least one packet header in a queue entry, the countdown indicates the length of the whole packet.

This countdown control information is needed to determine when the queue can safely start to readout a block downstream without interruption. This is mainly needed to cope with the speed matching requirements. In case of a slow writer, i.e., a slow queue write process and fast reader, i.e., a fast queue read process the reader uses the countdown and the speed ratio to calculate the optimal point in time to start the read of a block for minimal latency on one side and under run avoidance on the other.

### BRIEF DESCRIPTION OF THE DRAWINGS

The present invention is illustrated by way of example and is not limited by the shape of the figures of the drawings in which:

FIG. 1 is a schematic overview block diagram representation of a prior art data interface circuit (stream direction is upward),

FIG. 2 is a schematic overview representation of an interface circuit implementation comprising a central queue according to the present invention (stream direction is upward),

FIG. 3 is a more detailed depiction of the queue 24 in FIG. 2, (stream direction is downward),

FIG. 4 is a detailed schematic block diagram illustration of the generation of queue entry description bits,

FIG. 5 is a detailed schematic block diagram illustration of the queue entry decoding/de-multiplexing into a block header and a block data aspect,

FIG. 6 is a control flow diagram when writing a queue entry, comprising the essential control signal generation steps to be performed for managing the queue depicted in FIG. 2 and 3,

FIG. 7 is a control flow diagram when reading the control bits from a queue entry, for controlling the start and stop of the queue to be performed for managing the queue depicted in FIG. 2 and 3,

FIG. 8A is a symbolic representation of relevant control signals and data blocks in the write stream at the upstream begin of the queue in a sequence of 4 data shots,

FIG. 8B is a symbolic representation of relevant control signals and data blocks in the read stream at the output register of the queue, when a control signal signalling an unconditioned repeat, as for example “repeat queue entry” is provided for the queue control logic,

FIG. 8C is a symbolic representation of relevant control signals and data blocks in the read stream at the output register of the queue, when a control signal signalling a conditioned repeat, e.g. “repeat if stopped” is provided for the queue control logic.

### DETAILED DESCRIPTION OF THE PREFERRED EMBODIMENT

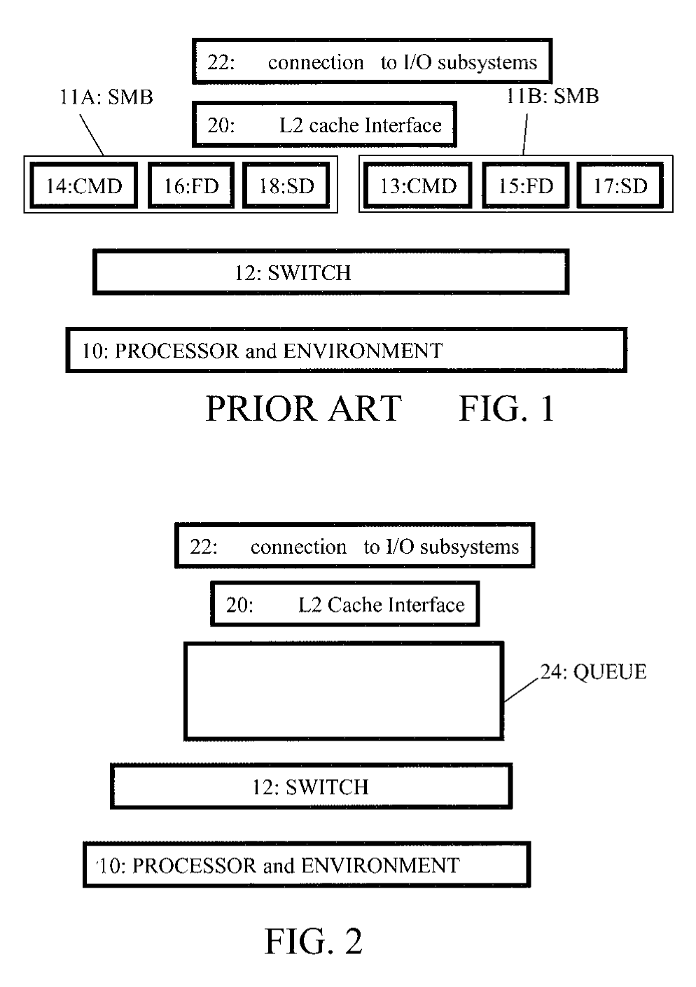

With general reference to the figures and with special reference now to FIG. 2 a queue implementation 24 is shown inserted instead of the buffer arrangement 11A and 11B in FIG. 1.

With reference to the following figures an application is described in which the term “packet” is used in a sense which coincides exactly to the more general term “block” as used before and within the claims.

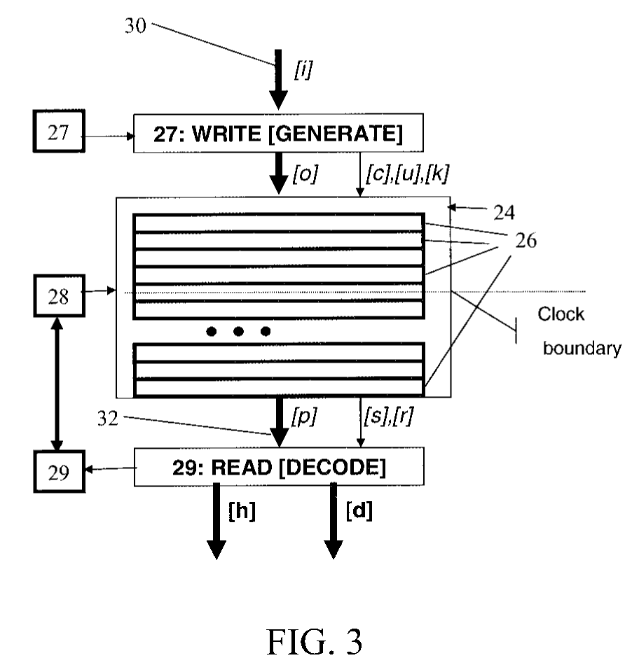

With reference to FIG. 3 a write queue client logic 27 is provided according to the invention which enriches the Inbound payload [i] 30 by a set of control signals each of which encodes a particular semantic meaning required for make a queue control logic 28 control the queue movement with basic orders as “stop”, “continue”, “repeat last entry and continue”, in order to manage its output register correctly for the actual application.

In this exemplary embodiment these control signals are:
conditional repeat [c],
unconditional repeat [u] and
a countdown [k].

Advantageously, the queue 24 needs no knowledge about the semantic meaning of the payload contained in each queue entry 26. The only signals treated by the queue control logic 25 are [c], [u] and [k], that are stored in parallel with the payload into one queue entry. Signals [s] and [r] are generated by a decode logic 29 at the downstream end of the queue with respect to the internal state of the queue and depending on the signals [c], L[u] and [k] of a particular queue entry 26.

In particular, the signal “Stopped on partial entry” [s] is generated whenever the queue is signalled by the control bit evaluation logic 27 that a streamed readout of all data according to one header is possible, and the entry was indicating a conditional repeat signal [c].

Further, with respect to an exemplary embodiment of the invention wherein the decode logic operates stateless, the signal “Repeated entry” [r] is generated whenever the queue shows an [u]—flagged entry the second time. This is needed to tell the downstream logic, which block—enumerated by its position in the decode window—has to be processed at a particular cycle. In this stateless implementation of the decode logic the [u] flag is needed to tell the decode logic, that a part of the entry has already been decoded at the time the entry was shown the first time. In a more general sense this might be reflected generally by an Integer number for coding e.g. 1^{st} repeat, 2^{nd} repeat 3^{rd} repeat, etc. Causing the decode logic to process the portion for the 1^{st} repeat, 3^{nd} portion for the 2^{nd} repeat and so on.

If only two blocks can start in a single entry such a single flag meaning “1^{st} repeat” is sufficient.

According to this general aspect it is disclosed that, if the logic attached is only capable to cope with the start of a certain number of packet starts at a time—this preferred embodiment deals with one packet starts at a time—and if multiple blocks starts may appear within one entry, which may be dictated by the queue write process as this is the case in the sample implementation of this disclosure, the entry has to be given to the downstream logic multiple times. In the present embodiment this is once for each block-start within the entry. However, it should be added that as described before the last block-start of an entry may have to be delayed because of under run prevention in case of slow writer.

The following descriptions are based on a scenario where a single repeat is sufficient to deal with the packets. The algorithm can easily be adapted and scaled for other numbers of repeats.

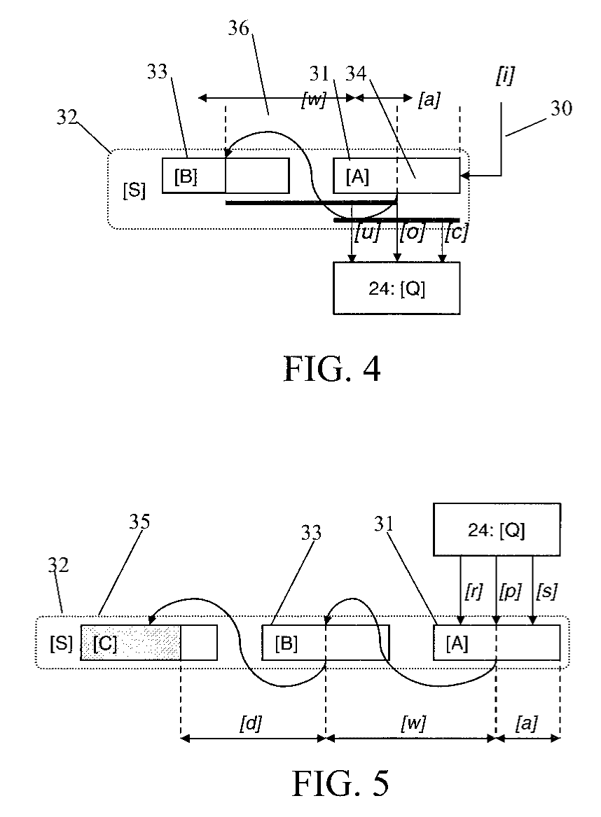

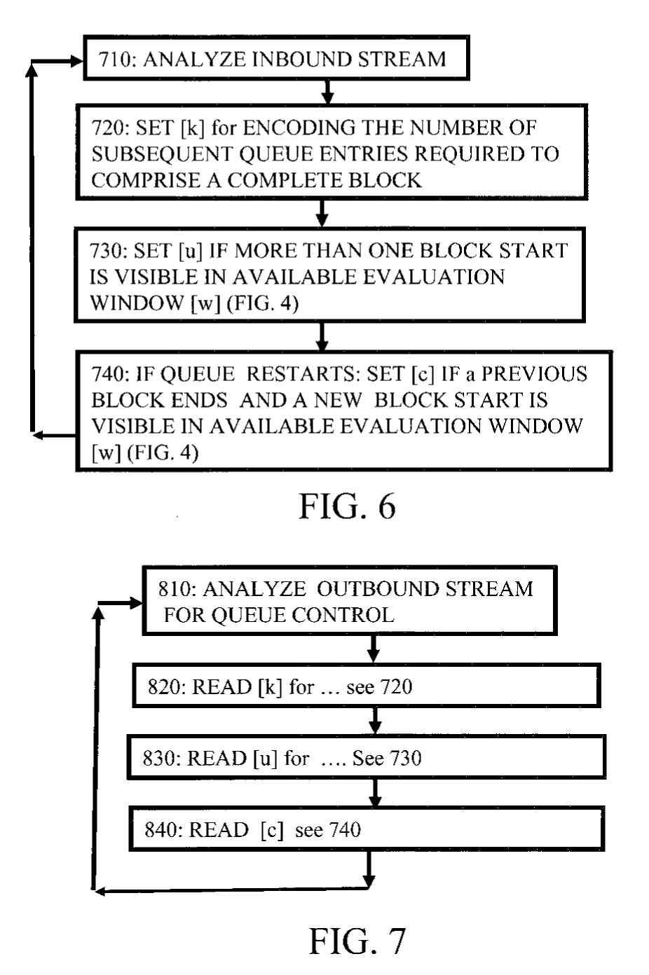

With additional reference to FIG. 4 the generation of unconditional repeat [u] and conditional repeat [c] signals in the write queue logic 27 is described in more detail. Hereby, the following abbreviations and definitions denoted as [def] apply:
def: segment:=[seg size]
A “segment” describes an atomic data element which reflects the granularity of context changes within an e.g. parallel data path as present herein in a single queue entry. A context change represents e.g. a header start, data start, header end, data end.
def: segment size:=[seg_size]
An exemplary bitlength is 32 Bit. Variations thereof may vary from 1 to x (where x is an element of N) This is thus the bitwidth of [seg].
The following formulae show the relations based on [seg].
def: payload:=[p]
def: payload length:=[p_length]
An exemplary bitlength of [p] is [p_length]*[seg_size]=128
Bit. Variations of [p_len element of N). “p” is thus the number of parallel data segments in the payload.
def: maximum length of header:=[max_hdr_length]
An exemplary bitlength is
[max_hdr_length]*[seg_size]=3*32 Bit=96 Bit. Variations thereof may vary from 1 to z (where z is an element of N). This is thus the maximum length of a header based on [seg].
def: minimum length of header:=[min_hdr_length]
An exemplary bitlength is
[min_hdr_length]*[seg size]=1*32 Bit=32 Bit. Variations thereof may vary from 1 to v (where v element of N).
def: minimum packet length:=[min_pkt_length]
An exemplary bitlength is
[min_pkt_length]*[seg_size]3*32 Bit=96 Bit
def: maximum packet length:=[max_pkt_length]
An exemplary bitlength is
[max_pkt_length]*[seg_size]=67*32 Bit=2144 Bit
def: header demux window:=[w]
An exempary bitlength is
[w]*[seg_size]=4*32 Bit=128 Bit. This is the window wherein header starts trigger a header demultiplexing.
def: header demux appendix:=[a]=[max_hdr_length]−1
An exemplary bitlength is
([max_hdr_length]−1)*[seg_size]=(3−1)*32 Bit=64 Bit.
Variations there of may vary from 0 to u (u element N)
This parameter [a] ensures that a header starting in [w] can be completely de-multiplexed in that particular cycle. More generally, the appendix can be set according to the maximally needed segments for the cycle in which the header is de-multiplexed.
def: data demux appendix:=[d]=[payload_length]−
[min_hdr_length]
An exemplary bitlength is
([payload_length]−[min_hdr_length])*[seg_size]=(4−1)*32 Bit=96 Bit. This parameter [d] ensures that data according to a header can be demultiplexed in a subsequent cycle. This parameter may vary according to the protocol on the downstream side of the queue.
def: demux buffer:=b_length=[d]+[w]+[a]
An exemplary bitlength is
([d]+[w]+[a])*seg_size=(3+4+2)*32=288 Bit. This represents a data buffer required to support header and data de-multiplexing in an environment with a separate header bus as well as a data bus.
An exemplary dataset is given as follows:
[seg_size]=17 Bit
[p_length]=6=>102 Bit
[max_hdr_length]=4=>68 Bit
[min_hdr_length]=3=>51 Bit
[min_pkt_length]=3=>51 Bit
[max_pkt_length]=40=>680 Bit
[w]=6=>102 Bit
[a]=3=>51 Bit
[d]=3=>51 Bit
[b_length]=204 Bit
A further exemplary dataset is given as follows:
[seg_size]=33 Bit
[p_length]=4=>132 Bit
[max_hdr_length]=3=>99 Bit
[min_hdr_length]=1=>33 Bit
[min_pkt_length]=3=>99 Bit
[max_pkt_length]=68=>2244 Bit
[w]=4=>132 Bit
[a]=2=>66 Bit
[d]=3=>99 Bit
[b_length]=297 Bit

The inbound stream [i] 30 generally consists of a number of [1] parallel data shots. The inbound stream 30 is fed into the shift register [S] 32. It consists of the registers [A] 31 and [B] 33, where register [B] 33 shows the value of [A] at the time (t−1).

The control signal “unconditioned repeat” [u] is generated by logic 27 whenever there is more than one packet header start in the window [w] 36. The appendix [a] 34 ensures that a packet header that starts in the window [w] 36 fully resides in register [A] 31.

The control signal “conditional repeat” [c] guides the queue 24 how to behave on a stop/restart condition. This signal is generated whenever a previous packet will end and also a new packet will start in register [A] 31, which is not fully present in register [A] at this particular time (t).

With additional reference to FIG. 5 the de-multiplexing of a command header denoted by “cmd hdr” and the de-multiplexing of data is described in more detail.

The queue 24 [Q] writes the payload [p] to the shift register 32 [S]. The data is fed in register 31 [A] while [A] is moved to register 33 [B] and register [B] is moved to a register 35 [C]. The inspector sets the the header multiplexer denoted as “header mux” to the leftmost header start bit “header start” in [w].

Whenever there is a [s] signal read, which means that queue 24 [Q] stopped on an entry 26 with the [c] condition, no header in [A] will be decoded until the signal is gone. After the pause the same shot appears in [A] but without the [s] condition which reactivates the decoder.

With reference to FIG. 6, 7 the control flow of the write logic 27 and that of the read logic 29 (see FIG. 3) is described in more detail.

The control flow of the write logic generating the important control signals for the queue management is depicted to comprise a general step 710 of analysing the inbound stream 30. In particular the number of subsequent queue entries k required to comprise a complete block, here a complete command, is always encoded independently of the composition of a data shot.

In step 730 the condition is checked if more than one block start is visible in the available evaluation window w, see back to FIG. 4. If this condition is met then the control signal u (repeat entry without any condition) is set to 1.

In a step 740 the queue restart condition is managed by setting control signal [c] if a previous block ends and a new block begin is visible in the available evaluation window w, FIG. 4 (unconditioned setting of the repetition control signal).

FIG. 7 shows the read logic 29 performing a first step 810 of analysing the outbound stream for the queue control logic 28. Generally, the parameter k is always evaluated in order to be informed of a length of a block or specifically, the length of a command. If k is for example set to 6, then it is known that the current block extends into the next 6 data shots.

It should be added that the countdown [k] is not related to the signal generation of [c] and [u]. For the speed-matching however, [k] is needed to ensure that the queue read process only passes the queue entries to the client side when the whole packet can be processed without interruption.

In a step 830 the control signal u is read and evaluated in order to affect a repetition of the last queue entry at the output register of the pipe queue when this condition is met.

In step 840, the presence of control signal c is monitored in the same way.

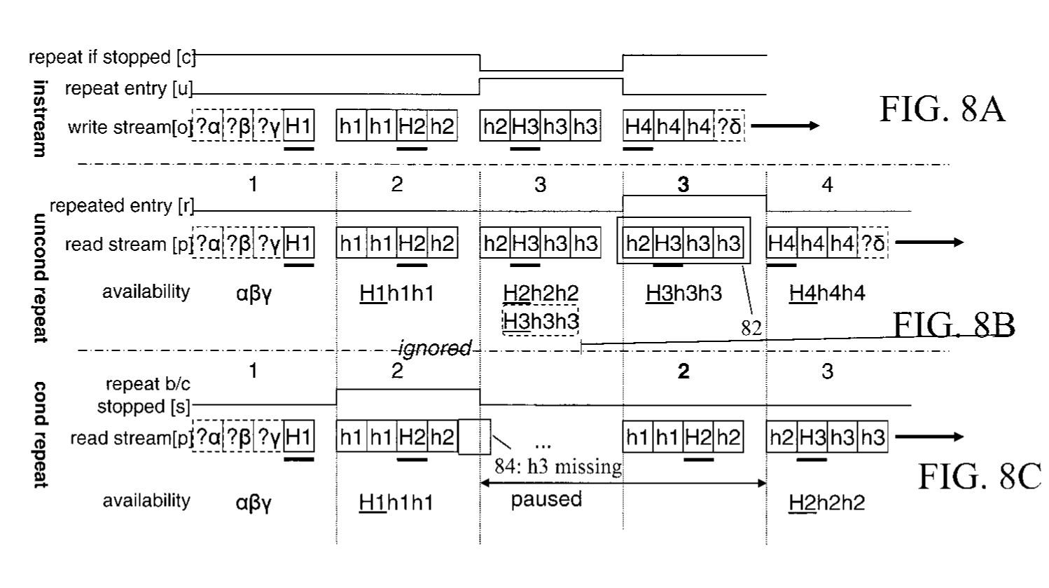

With reference to FIG. 8 an exemplary and typical scenario of outbound vs. inbound stream of queue 24 is described in more detail, illustrating the fact that outbound and inbound streams are processed independently from each other.

Hereby, the following abbreviations and data apply:
H#—Start of header of packet #
h#—Subsequent parts of the header of packet #
?$—any data

The following scenario deals with the following values of data shots:
max_hdr_length=3
min_hdr_length=1
min_packet_length=3
payload_width=4

FIG. 8A is a symbolic representation of relevant control signals [c] and [u] and data blocks in the inbound write stream 30 at the upstream begin of the queue in a sequence of 4 data shots.

The write logic 27 generates both signals c, u as described before. In the write stream 30 a rest of the last processed command is denoted with alpha, beta, gamma which is not taken into consideration in this example.

Then the start of packet 1 is denoted by H1 in the last section of data shot 1. In the next data shot 2 two subsequent parts of the header of packet 1 are depicted as h1. In the next section the start of the header of packet 2 denoted as H2 is placed and followed by one subsequent part h2 in the second data shot. In the third data shot the second subsequent part of the header of packet 2 is present in the first section of data shot 3. Then in the second section of data shot 3 the third data packet is started with header H3 and two subsequent part of headers h3. Finally, in the fourth data shot the fourth data packet begins (H4) followed by two subsequent header parts h4. The last section in data shot 4 is not taken into consideration for this example.

FIG. 8B is a symbolic representation of relevant control signals and data blocks in the read stream 32 at the output register of the queue, when a control signal signalling an unconditioned repeat, as for example “repeat queue entry” is provided for the queue control logic.

In FIG. 8B a continuous read stream 30 is shown, wherein in the first data shot the rest of the before-mentioned command is available, see the “availability row”; in the second data shot the header of the first data packet is available and processed and in the third data shot the second data packet with header H2 is available. Due to the fact, however, that in the write stream of data shot 3 data packet 3 has already been displayed but not yet processed; the data shot 3 must be repeated in order to handle the header of data packet 3. This is shown in frame 82. After this has been completed, in data shot 4 the header of data packet 4 can be processed. As reveals from FIG. 8A this repetition is controlled by the “repeat entry” signal u to be set from 0 to 1 at the time of data shot 3, see the second row of FIG. 8A. This reflects the regular, foreseeable case emerging when three data packets covering each three sections of a data shot followed to each other in a window having only for sections.

FIG. 8C is a symbolic representation of relevant control signals and data blocks in the read stream 32 at the output register of the queue, when a control signal signalling a conditioned repeat, e.g. “repeat if stopped” is provided for the queue control logic.

In FIG. 8C a trivial case is illustrated in which the queue must be stopped because the third part of header H2 (see the frame 84) is still missing and not yet available at the down stream end of the queue at the time of data shot 2. Thus, the queue must be stopped and after a certain pause the queue is restarted which is depicted in data shot 4. Thus, a full header of data packet 2 is available in the third data shot, as the second data shot had been repeated according to the invention after the queue has been restarted. In the next data shot the header of data packet 3 can be read out of the outbound stream 32 .

With reference back to FIG. 8A the control signal of the first row “repeat if stopped” [c] is set always ON except when data shot 3 arrives in the read stream, in order to manage this in a general way for all cases relevant. When, however, the signal repeat entry (unconditioned repeat) is ON, then the conditioned repeat [c] control signal must be reset to OFF, in order to give the unconditioned repeat the higher priority.

From that description as given above, thus in summary, the following advantages yield: The queue states and properties have no implication on the generation [G] as well as the decoding logic [D]. Only the queue depth is relevant to support a number of back-to-back commands.

The storage is on-demand distributed to the tasks of supporting long packets and supporting a big number of back-to-back commands.

The present invention can be realized in hardware, or a combination of hardware and software. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product such as an ASIC, for example a FPGA, which comprises all the features enabling the implementation of the methods described herein, and which—when installed in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A method for transferring a stream of data from a first higher-speed subsystem of a computer to a plurality of lower speed subsystems, wherein the stream is structured in a sequence of blocks of different bit length, and a block is to be transferred to a specific one of said lower-speed subsystems, characterized by the steps of:
a) using a queue for buffering the data,
b) when writing a block of data into a queue entry including control bits into the same queue entry, wherein the control bits encode the further processing relevant for the association of the data block with a specific one of said lower-speed subsystems, when the queue entry is decoded at the output register of the queue.

2. The method according to claim 1, wherein a control bit [u] of the control bits indicates that one and the same queue entry must be read multiple times, in order to process a respective number of data blocks occurring in said queue entry.

3. The method according to claim 1, wherein a control bit [c] of the control bits indicates that a current queue entry must be repeatedly read after a stop of the queue.

4. The method according to claim 1 wherein a countdown indicator [k] of the control bits indicates the number of required queue entries needed for finishing a current block.

5. The method according to claim 1, used for providing speed-matching and alignment of commands in a computer system wherein the commands build the blocks of different length and are processed by one or more higher speed Processing Units and are distributed to multiple different lower-speed Input/Output (I/O) subsystems.

6. A computer system arranged for transferring a stream of data from a first higher-speed subsystem of the computer to a plurality of lower speed subsystems, wherein the stream is structured in a sequence of blocks of different bit length, and a block is to be transferred to a specific one of said lower-speed subsystems,
characterized by having a queue for buffering the data and control logic for performing the steps of a method according to claim 1.

7. A computer program for execution in a data processing system comprising a queue for buffering the data, and a functional component for performing the step of:
when writing a block of data into a queue entry), including control bits into the same queue entry, wherein the control bits encode the further processing relevant for the association of the data block with a specific one of said lower-speed subsystems, when the queue entry is decoded) at the output register of the queue,
when said computer program is executed on a computer.

8. A computer program product stored on a computer usable medium comprising computer readable program means for causing a computer to perform the method of anyone of the claim 1,
when said computer program product is executed on a computer.
